(19) United States
(12) Patent Application Publication
(10) Pub. No.: US 2010/0306195 A1
(43) Pub. Date: Dec. 2, 2010

(54) METHOD AND SYSTEM FOR CREATING QUERIES FOR COMPLEX DATA STRUCTURES

(76) Inventors: Andreas Wagener, Siegen (DE); Jens Popp, Dortmund (DE); Dick Ortloff, Hagen (DE)

Correspondence Address: WELSH & FLAXMAN LLC, 2000 DUKE STREET, SUITE 100, ALEXANDRIA, VA, 22314, US

(21) Appl. No.: 12/475,938

(22) Filed: Jun. 1, 2009

(51) Int. Cl. G06F 17/30; G06F 3/048

(52) U.S. Cl. 707/736; 715/764; 715/769; 707/954

(57) ABSTRACT

A system for creating queries for complex data structures includes a database populated with data relating to a manufacturing process and a graphical user interface accessed via a computer. The graphical user interface includes a tree domain and a query area, the tree domain including a tree representation of the data populating the database, wherein the tree representation includes graphical representations of attributes and/or structural-elements relating to the manufacturing process and populating the database. A mechanism is provided for dragging and dropping the graphical representations from the tree domain to the query area where the graphical representations are converted to a query based upon operators linking the graphical representations dragged and dropped from the tree domain.

### BACKGROUND OF THE INVENTION

1. Field of the Invention

The present invention relates to a mechanism for storing, managing, retrieving and sorting data relative to the development of high tech manufacturing processes. Since the data is very complex in its structure, new mechanisms for processing the data are necessary. More particularly, the invention provides a flexible and easy to use way to build search queries for complex data structures. The present invention focuses on the ease of use for engineers while maintaining the power of the search query.

2. Description of the Related Art

The data handled while developing new manufacturing processes for high-tech industries is very complex. Referring now to FIG. 1, a simplified version of the data modeling for a single process step in a manufacturing process is disclosed. Multiple steps need to be combined to obtain a complete manufacturing instruction. Additionally, a great deal of supporting data (for example, parameters, units, materials, etc.) is needed to provide a complete description. Once developed, the manufacturing processing sequence needs to be proven in experiments. Performing these experiments results in a lot of valuable data that is stored by such systems. However, the storage is only the first part of the tasks necessary. As a result, a new mechanism for querying data is required.

### SUMMARY OF THE INVENTION

It is, therefore, an object of the present invention to provide a system for creating queries for complex data structures including a database populated with data relating to a manufacturing process and a graphical user interface accessed via a computer. The graphical user interface includes a tree domain and a query area, the tree domain including a tree representation of the structure of the data populating the database, wherein the tree representation includes graphical representations of attributes and/or structural-elements relating to the manufacturing process and populating the database. A mechanism is provided for dragging and dropping the graphical representations from the tree domain to the query area where the graphical representations are converted to a query based upon operators linking the graphical representations dragged and dropped from the tree domain.

It is also an object of the present invention to provide a system wherein the database is a relational database.

It is another object of the present invention to provide a system wherein the query is an XML query.

It is a further object of the present invention to provide a system wherein the operators are Boolean operators.

It is also an object of the present invention to provide a system wherein the operators are AND, OR and NOT.

It is another object of the present invention to provide a system wherein the data is selected from the group consisting of wafers, materials, parameters, units, single process steps, process step parameters, process step rules, process flows, lots, experiments, users, groups, material types, wafer types, process step types, projects, assessments, wafer pieces, artifacts with linked documents, masksets, tools, models, and machines.

It is a further object of the present invention to provide a system wherein a server links the graphical user interface of the computer to the database.

It is also object of the present invention to provide a system wherein the server converts the query generated by the graphical user interface of the computer into an SQL query.

It is another object of the present invention to provide a system wherein the query generated by the graphical user interface of the computer is an XML query.

It is a further object of the present invention to provide a method for creating queries for complex data structures. The method also includes providing a graphical user interface accessed via a computer, the graphical user interface including a tree domain and a query area. The graphical user interface is linked with a database populated with data relating to a manufacturing process, the graphical user interface including a tree domain having a tree representation of the structure of the data populating the database, wherein the tree representation includes graphical representations of attributes and/or structural-elements relating to the manufacturing process and populating the database. The graphical representations are selectively dragged and dropped from the tree domain to the query area where selected graphical representations are converted to a query based upon operators linking the selected graphical representations dragged and dropped from the tree domain.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of a simplified version of the data modeling for a single manufacturing process step.

FIG. 2 is a schematic of the present system.

FIG. 3 is a flow chart showing the flow of queries and results in accordance with a preferred embodiment of the present invention.

FIG. 4 is a flow chart showing the creation of queries in accordance with the present invention.

FIGS. 5 through 10 are screen shots of a graphical user interface during the steps of the present invention.

FIG. 11 is a screen shot of an example for a table of process steps with data.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

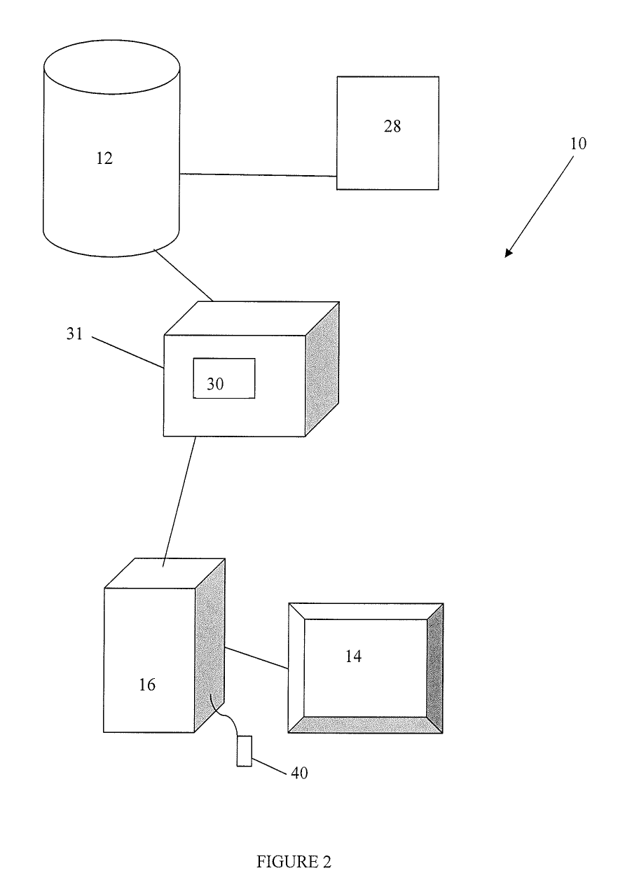

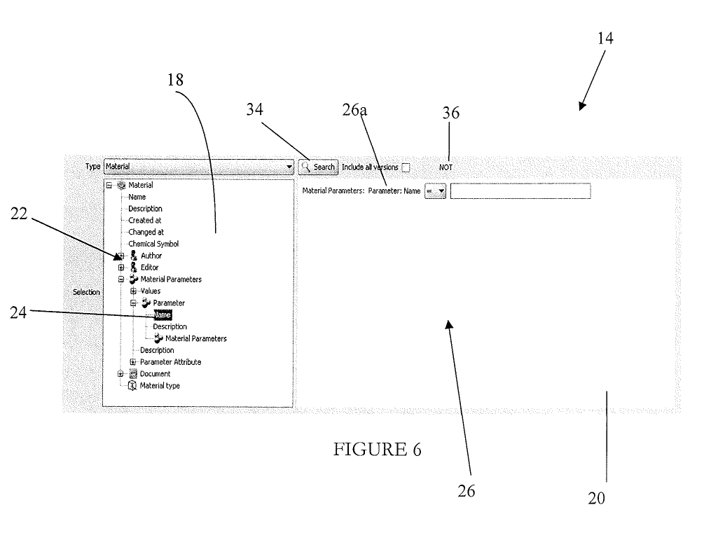

The present invention provides a method and system for conveniently and flexibly building queries for complex data structures. Briefly and with reference to FIGS. 2 to 10, the system 10 includes a database 12 populated with data relating to a manufacturing process 28. As will be discussed below in greater detail, the database contains information about the design and execution of the manufacturing process with historical data (for example, change in the production state of the wafer with the time stamp). A graphical user interface 14 accessed via a computer 16 is linked to the database 12. The graphical user interface 14 includes a tree domain 18 and a query area 20. The tree domain 18 includes a tree representation 22 of the structure of the data populating the database 12, wherein the tree representation 22 includes graphical representations (or objects) of attributes and/or structural-elements 24 (herein also referenced as “attribute/structural-element graphical representation(s) 24” or “graphical representation(s) 24”) relating to the manufacturing process 28 and populating the database 12. The graphical user interface 14 further includes a mechanism for dragging and dropping the attribute/structural-element graphical representations 24 from the tree domain 18 to the query area 20 where the attribute/structural-element graphical representations 24 are converted to a query 26 based upon Boolean logic linking the attribute/structural-element graphical representations 24 dragged and dropped from the tree domain 18. As will be appreciated based upon the following disclosure, the queries 26 generated in the query area 20 of the graphical user interface 14 are graphical depictions of a query 26 which is later converted to an XML query and an SQL query for searching of the database 12 in accordance with the present invention. It should be appreciated that an XML query is intended to refer to a query generated in accordance with the present invention that is described using XML.

As such, the present system 10 is implemented by providing a graphical user interface 14 accessed via a computer 16, wherein the graphical user interface 14 includes a tree domain 18 and a query area 20. The graphical user interface 14 is linked with a database 12 populated with data relating to a manufacturing process 28. The graphical user interface 14 includes a tree domain 18 having a tree representation 22 of the structure of the data populating the database 12, wherein the tree representation 22 includes graphical representations of attributes and/or structural-elements 24 relating to the manufacturing process 28 and populating the database 12. The attribute/structural-element graphical representations 24 are selectively dragged and dropped from the tree domain 18 to the query area 20 where the selected attribute/structural-element graphical representations 24 are converted to a query 26 based upon Boolean logic linking the selected attribute/structural-element graphical representations 24 dragged and dropped from the tree domain 18.

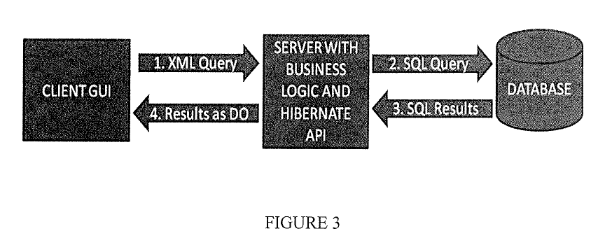

Referring to FIGS. 2 and 3, the system 10 is implemented in a three or multitier architecture. By providing a graphical user interface 14 on a client computer 16 and linking the graphical user interface 14/client computer 16 with a server computer 31 which converts the XML query generated by the user at the graphical user interface 14/client computer 16 based upon the query 26 created in the query area 20 to an SQL query for accessing the database 12 which is linked to the server computer 31. The SQL query is directly sent to the database server 12 via an API called JDBC (Java Database Connectivity). As discussed below in greater detail, the SQL query is created by Hibernate Criteria and Hibernate Search API. The server feeds this APIs, that is, it converts the XML query data sent from the client computer 16 into valid Criteria for the Hibernate Criteria API and valid queries for Hibernate Search.

The results of the query are then transmitted from the database 12 as an SQL data sent back via the JDBC API to the server 31 where the results are converted to data objects and transmitted to the graphical user interface 14/client computer 16 for viewing by the user. While data objects, in particular, Java Objects, are employed in accordance with a preferred embodiment of the present invention, it is contemplated other representations of the data structure may be employed (for example, comma separated list). In addition, while the queries are referred to as SQL queries or XML queries, it is contemplated they may be in a variety of formats, for example, the XML query and/or SQL query can be transported in file formats or data-object, that is, a String.

The present system 10 allows ease of use for engineers while maintaining the power of the search query. As discussed above, the system 10 and method are implemented using a graphical user interface 14 upon a computer 16 linked to a server 31 and ultimately the database 12 in which the relevant information relating to the manufacturing process is stored.

As briefly discussed above, the present invention provides a mechanism for storing, managing, retrieving and sorting data relative to the development of high tech manufacturing processes. Since the data is very complex in its structure, the present invention provides a system 10 and method for processing the data. More particularly, the invention provides a flexible and easy to use mechanism for building queries for complex data structures. The present invention focuses on the ease of use for engineers while maintaining the power of the search query.

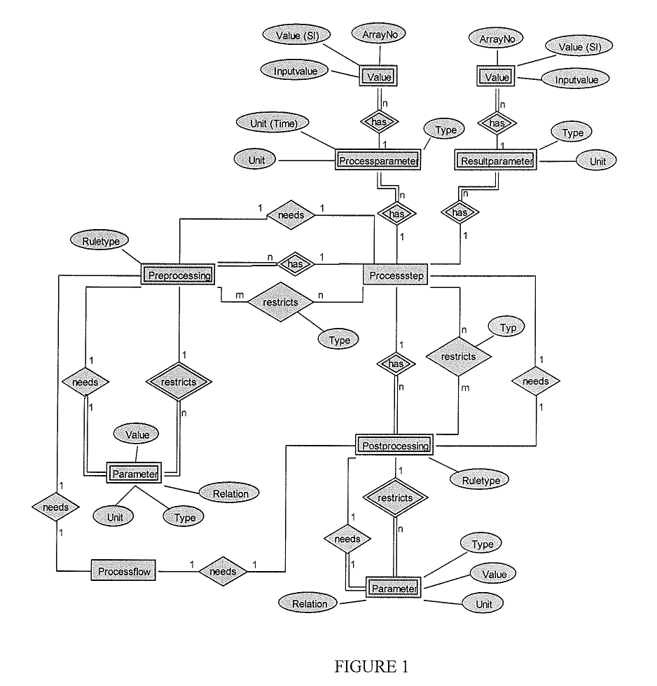

As briefly discussed above, a simplified version of data modeling for a single process step in a manufacturing process is shown in FIG. 1. As FIG. 1 shows, each process step involves various processing parameters, result parameters, preprocessing steps and post processing steps associated therewith on a conditional basis. The preprocessing and post processing steps associated with the processing step at issue also include parameter concerns.

In practice, multiple process steps are combined to obtain a complete manufacturing instruction. As should be appreciated based upon the simplified modeling of a process step disclosed above, a great deal of supporting data (for example, parameters, units, materials, etc.) is associated with each process step and is, therefore, needed to provide a complete description of the process step.

Once developed, the processing sequence, that is, the combination of processing steps making up the complete instruction for the manufacturing process, is proven in experiments and these experiments result in a lot of valuable data that is stored and accessed by the present system. However, storage of the data generated during the design, testing and implementation of the manufacturing process is only the first part of the tasks necessary for developing a manufacturing process. With all the available data generated as a result of the design, testing and implementation of the manufacturing process, the present system 10 and method provide a mechanism for querying the data to conveniently and efficiently access data that will be helpful in the process of designing, testing and implementing the manufacturing process.

The data generated as a result of the development, design, implementation, testing, experimentation, etc., of the manufacturing process is valuable and the present system 10 and method allows one to readily and conveniently access the data which is ultimately stored in a database 12. In practice, and in accordance with a preferred embodiment, the data populating the database 12 results from actual design, testing, development, implementation, etc. of the manufacturing process 28 at issue. For example, the data may be generated as a result of actual practice of the manufacturing process 28, experimentation with machinery associated with the manufacturing process 28 or other efforts associated with the development or operation of the manufacturing process 28. This data may come from the machinery itself, may be manually input or can be automatically input into the database 12 from a central monitoring system. Regardless of the source of the data or the mechanism for input of the data, a great deal of the information is generated which is related to the operation of a particular manufacturing process 28.

While the above disclosure discusses data generated as a result of actual testing and development associated with a particular manufacturing process, it is contemplated data may be developed through simulation of the manufacturing process and that this data may also be incorporated into a database for retrieval in accordance with the present invention.

In accordance with the present invention, a manufacturing process 28 is developed and data relating to the manufacturing process 28 is provided. The information provided includes, but is not limited to, parameters, units, materials, etc. With the manufacturing process developed, the feasibility of the manufacturing process 28 is tested using experimentation. As discussed above, the experimentation generates valuable data. This data is stored in a database 12 by the present system 10 in a structured manner and ultimately retrieved using the present system 10.

In accordance with a preferred embodiment, the data is stored in a relational database structure for example, using an Oracle database structure, that is, a database management system such as a RDBMS (Relational Database Management System). A relational database is a collection of data items organized as a set of formally-described tables from which data can be accessed or reassembled in many different ways without having to reorganize the database tables. The standard user and application programming interface to a relational database is Structured Query Language (SQL). SQL statements are used both for interactive queries for information from a relational database and for gathering data for reports. In addition to being relatively easy to create and access, a relational database has the important advantage of being easy to extend. After the original database creation, a new data category can be added without requiring that all existing applications be modified.

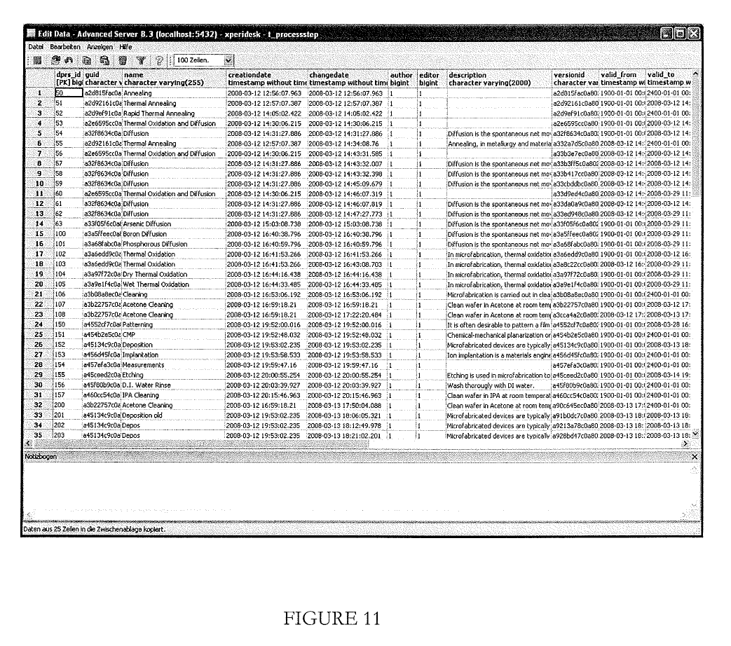

As those skilled in the art will appreciate, the data making up the relational database is organized in a set of tables containing data fitted into predefined categories. Each table contains one or more data categories in columns. Each row contains a unique instance of data for the categories defined by the columns. For example, a database relating the manufacturing process contemplated in accordance with the present invention could include tables that describe wafers, materials, parameters, units, single process steps, process step parameters, process step rules, process flows, lots (a lot is a collection of wafers), experiments, users, groups, material types, wafer types, process step types, projects, assessments, wafer pieces, artifacts with linked documents, masksets, tools, models, machines and other entities needed to describe the design and execution of a production processes. For example, and with reference to FIG. 11, each of these tables needs a set of general data like:

| | |
|---|---|
| Name | The name of the entity (e.g. the name of |
| | the material or process step) |
| Author | The user that created the entity |
| Editor | The user that last edited the entity |
| Version | The version of the entity (to store the |
| | change history of the entity each edit |
| | creates a new version and with each |
| | version this number would be |
| | incremented) |
| Creation date | The date and time the entity was created |
| . . . and others | |

Additionally entities can contain special fields. A process step needs for instance:

| | |
|---|---|
| Process parameters | A list (in a related table) of parameters for |
| | this process step, that can be adjusted by |
| | the user |
| Result parameters | A list (in a related table) of parameters for |
| | this process step, that are measured or |
| | expected as a result of the process step |
| Operator | A person that is responsible for the |
| | execution of the process step |
| . . . and others | |

When creating a relational database, one can define the domain of possible values in a data column and further constraints that may apply to that data value. It should also be noted the table categories listed above are domain specific for semiconductor and semiconductor based micro-system technologies. For example, the tables for a bioMST (that is, BioMicrosystem Technologies (bioMST); for example, microfluidic devices, biochips to test for cancer cells, test chips for blood samples, generally speaking bringing together MicroSystem Technologies and biology) domain model could be “micro-array” or “substrate” instead of wafer and “experimental series” instead of “wafer” without departing from the spirit of the present invention.

In accordance with a preferred embodiment of the present invention, the queries must support the Boolean algebra (that is, AND, OR, NOT, or any combination thereof). The query generation mechanism first results in a generic XML query description of the query 26, which is generated by the user employing the graphical user interface 14/client computer 16, that is ultimately transmitted to a server 31, where the XML query is converted to an SQL query that can be used by the query engine 30 of the server 31 for accessing and identifying information maintained within the process database 12. As discussed below in greater detail, the SQL query is generated by a combination of the query engine 30 (e.g. Hibernate Criteria API) and code that evaluates the XML and translates the XML into valid criteria for the Hibernate Criteria API. Although Hibernate Criteria API is used in accordance with a preferred embodiment of the present invention, it is contemplated other APIs may be used, for example, TOPLINK from Oracle, which provides similar functionality although achieved in a slightly different ways, could be used as well without departing from the spirit of the invention. The SQL evaluation is done by the Relational Database Management System (RDBMS) of the database 12, for example, Oracle.

As those skilled in the art will appreciate XML (Extensible Markup Language) is a flexible way to create common information formats and share both the format and the data on the World Wide Web, intranets, and elsewhere. XML contains markup symbols to describe the contents of a page or file. XML describes the content in terms of what data is being described. This means that an XML file can be processed purely as data by a program or it can be stored with similar data on another computer or it can be displayed. XML is “extensible” because the markup symbols are unlimited and self-defining.

With regard to SQL, SQL (Structured Query Language) is a standard interactive and programming language for getting information from and updating a database. Queries take the form of a command language that lets you select, insert, update, find out the location of data, and so forth. There is also a programming interface. In accordance with a preferred embodiment of the present invention, Hibernate Criteria API (application program interface), or Hibernate Query API, is used by the server 31 in converting the XML query from the originally generated query into an SQL query that may be employed by the query engine 30 for accessing the database 12. The XML query is translated into valid criteria(s) for the Hibernate Criteria API at the server 31 prior to conversion to an SQL query. Hibernate Criteria API, by Red Hat Middleware, is a simplified API for retrieving entities by composing criterion objects. Hibernate Criteria API provides the ability to conveniently and dynamically build queries.

In accordance with a preferred embodiment, and as discussed above, the query engine 30 and the graphical user interface 14 do not run on the same computer 16. In fact, and with reference to FIGS. 2 and 3, the graphical user interface 14 preferably runs on a client computer, generates the XML query based upon the query 26 developed by the user as discussed herein and sends the XML query to a server computer 31 where the XML query is evaluated. Using code to convert the XML query to valid criteria for the Hibernate Criteria API and Hibernate Criteria API, the XML query is translated into an SQL query and sent to the server on which the database 12 is located. While multiple servers and a client computer are disclosed in accordance with a preferred embodiment, it is contemplated various network configurations may be employed within the spirit of the present invention. For example, it is contemplated the query engine and the graphical user interface might run on the same computer.

While Boolean operators and SQL formats are employed in accordance with a preferred embodiment of the present invention, it is contemplated other query and data formats may be employed within the spirit of the present invention. The system 10 and method described herein allows for easy creation of complex search queries. As discussed above, the present system 10 and method use a graphical user interface 14 accessed via a computer 16 to manipulate attribute/structural-element graphical representations 24, for example, by dragging and dropping selected attribute/structural-element graphical representations 24, to create the (graphical depiction of the) search queries 26. As will be appreciated based upon the following disclosure, detailed structured data can be handled and the query 26 can be understood by any engineer with basic background in Boolean algebra. An in-depth knowledge of the data structure to be queried is not necessary.

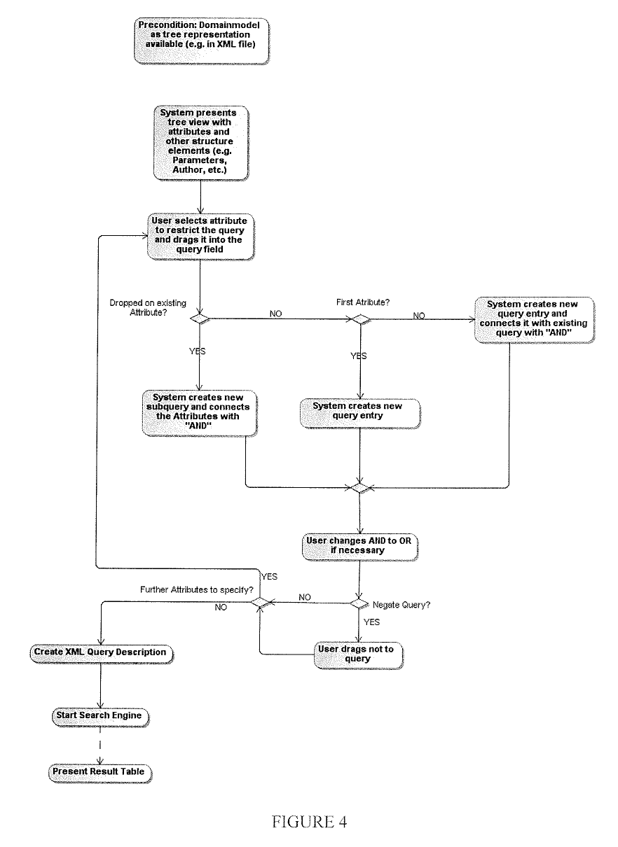

In general, and with reference to FIGS. 4 to 10, selected graphical representations 24 representing attributes and/or structural-elements of a manufacturing process 28 at issue are moved from a domain section (or tree domain) 18 of the graphical user interface 14, where the database 12 relating to the manufacturing process 28 is presented in the form a tree structure (or representation) 22, to a query area 20 of the graphical user interface 14, where the attributes and/or structural-elements at issue are organized in the creation of a query 26. These attribute/structural-element graphical representations 24, once moved to the query area 20, represent query elements ( or query entries) 26a-g relating to the attributes and/or structural-elements of the manufacturing process 28 about which the user desires to obtain additional information regarding the attribute and/or structural-elements. As the attribute/structural-element graphical representations 24 are moved to the query area 20 they are linked with other attribute/structural-element graphical representations 24 (which are already in the query area 20 as query elements 26a-g or will be moved to the query area 20) with which a user wants to establish a query 26 for identifying relevant information stored within the database. Boolean operators 32 are then used to link the various query elements 26a-g relating to the attributes and/or structural-elements for the creation of a query 26. The query 26 is then applied to the database 12 for the retrieval of desired information.

An example of the present invention is provided. In accordance with this example, and with reference to FIGS. 4 to 10, a query 26, in particular, a graphical depiction of a query, which is later converted to an XML query and an SQL query for searching of the database 12 in accordance with the present invention, is developed relating to determinations relating to a physical process relating to the intrinsic properties of a material used in the manufacturing process.

The domain model must first be presented in a tree representation 22, that is, a graphical representation of a tree structure employed in storing the data. As those skilled in the art will appreciate, a tree structure is an algorithm for placing and locating files (called records or keys) in a database. The algorithm finds data by repeatedly making choices at decision points called nodes. A node can have as few as one branch (for example, where the node is “user” and only one child “name”), or as many as several dozen. The structure is straightforward, but in terms of the number of nodes and children, a tree can be gigantic.

Records may be stored in nodes, in a special tree like two-three-trees, records are stored only in locations called leaves (that is, a node without children). This name derives from the fact that records always exist at end points; there is nothing beyond them. The starting point is called the root. The maximum number of children per node is called the order of the tree. The maximum number of access operations required to reach the desired record is called the depth. In some trees, the order is the same at every node and the depth is the same for every record. This type of structure is said to be balanced. Other trees have varying numbers of children per node, and different records might lie at different depths. In that case, the tree is said to have an unbalanced or asymmetrical structure.

The tree structure is represented upon the graphical user interface 14 used in accordance with the present invention as a tree representation 22 in the tree domain 18. With the tree representation 22 developed in conjunction with the database 12, the tree domain 18 is employed to identify various attributes and/or structural-elements of the manufacturing process 28 as stored within the database 12 (for example, parameters, author, etc.) for consideration. Located adjacent to the tree domain 18 is the query area 20, the operation of which will be discussed below in greater detail. Briefly, the user is able to select attribute/structural-element graphical representations 24 from the tree domain 18 for development of queries 26. In particular, the user identifies various attributes and/or structural-elements which may be queried (that is, query elements) in relation to the manufacturing process 28 at issue and drags the selected attribute/structural-element graphical representation 24 (that is, the icon or object representing the attribute or structural-element) from the tree domain 18 to the query area 20. As those skilled in the art will appreciate, “drag and drop” refers to the ability to move graphical user interface objects (or attribute/structural-element graphical representations 24), for example, icons and windows, by means of manipulating a mouse or other tracking device 40 (such as a trackball, touchpad or pointing stick).

Once the attribute/structural-element graphical representation 24 is dragged to the query area 20, it is determined whether the attribute/structural-element graphical representation 24 was dropped upon an attribute/structural-element graphical representation 24 already existing in the query area 20 as a query element 26a-g. If the attribute/structural-element graphical representation 24 is dropped upon a query element 26a-g relating to an attribute or structural-element existing in the query area 20, the system 10 creates a subquery and connects the new attribute or structural-element with the old attribute or structural-element via an AND operator 32.

If the graphical representation 24 of the new attribute or structural-element is determined not have been dropped upon a query element 26a-g representing the old attribute or structural-element existing in the query area 20, the system 10 determines whether it is the first query element for an attribute or structural-element being assigned to the query 26 under development. If it is the first query element for an attribute or structural-element being assigned to the query 26 under development, the system 10 creates a new query element, or query entry, 26a. If, however, it is not the first query element for an attribute or structural-element being assigned to the query 26 under development, the system 10 creates a new query entry, or query element, 26b and connects the new attribute or structural-element query entry with the previously existing attribute or structural-element query entry via an AND operator 32.

Regardless of whether the graphical representation 24 of the attribute or structural-element is dropped upon an existing query element representing an attribute or structural-element, the attribute or structural-element is the first being assigned to the query under development, or the attribute or structural-element is not the first attribute or structural-element being assigned to the query under development, the user may change the default Boolean operator 32 assigned to the operation, that is, and in accordance with a preferred embodiment of the present invention, the operator 32 may be changed from AND to OR and back. It will be appreciated that NOT can be applied in addition to an AND or OR so as to negate the binary operation or the NOT can be used as a unitary operator to negate the search attribute (that is, everything not fulfilling the attribute).

At this point the user selects whether to negate the query element or not. If the user chooses to negate the query element, the user drags a graphical depiction of a NOT operator 36 to the query 26 and adjacent the query element at issue. If the user decided not to negate the query element, the user simply proceeds.

Whether the user decides to negate the query element 26a-g or not, the user determines whether further query entries are required. If further query entries are desired, the user returns to the step of selecting graphical representations 24 of the attributes and/or structural-elements from the tree domain 18 for the creation of query elements 26a-g and dragging the attribute/structural-element graphical representation 24 from the tree domain 18 to the query area 20. Once the attribute/structural-element graphical representation 24 is dragged to the query area 20, the steps relating to dropping of the graphical representation 24 of the attribute or structural-element and assigning Boolean operators 32 is repeated. This process is repeated until the query 26 is complete with the desired operators.

If during the creation of a query 26, the user wishes to remove a query element 26a-g from the query 26, the user can drag the graphical depiction of the query element 26a-g from the query area 20 and back to the tree domain 18. The query 26 is changed accordingly, meaning that Boolean operators (if any) 32 used to connect the query element 26a-g to another query element(s) 26a-g are removed.

With the query complete, the computer first automatically creates an XML query which is ultimately transmitted to the server 31 and converted to SQL query, starts the query (or search) engine 30 on the server 31 and presents the results as a table. This is achieved in one step by the user pressing the search button 34 on the graphical user interface 14. The XML query description is created automatically based upon the query information place in the query area. As those skilled in the art will appreciate, the XML query description is constructed using an internal process.

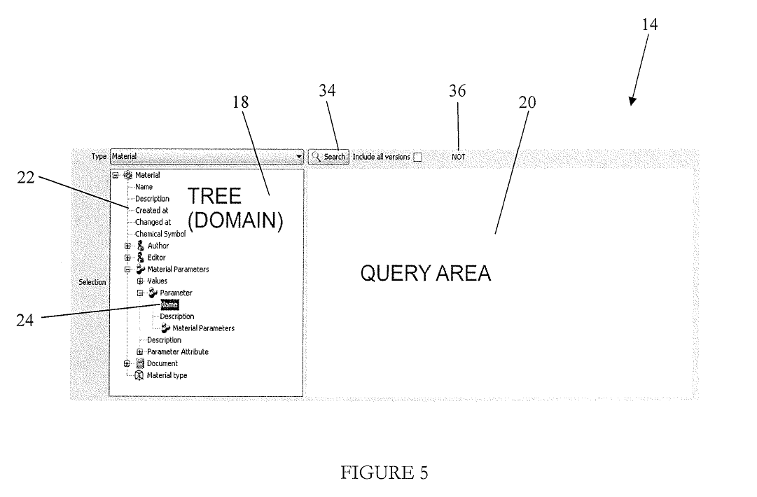

An example of the operation of the present system is provided with reference to FIGS. 5 to 10.

With the structure of the database 12 developed and the tree representation 22 established, the user first identifies a graphical representation 24 of an attribute or structural-element from the tree domain 18 he or she wishes to include in the query area 20. For example, and with reference to FIG. 5, the user chooses the graphical representation 24 of the Material Parameters: Parameter: Name. The meaning of this is: Search for “Material Parameters” that have a “Parameter” with “Name”. The “Material Parameter” is the concrete instance of a “Parameter” for the material. It contains the “Parameter”, the “unit” and the value(s). The parameter is only there to define the concrete instance. For example, for Aluminum the Material Parameter is “Melting Point=933.47K”, the “Parameter: Name” is Melting point, the value is “937.47” and the unit is “K”.

The graphical representation 24 of the Material Parameters: Parameter: Name attribute is then dragged from the tree domain 18 and dropped in the query area 20. The system 10 then determines whether the graphical representation 24 of the Material Parameters: Parameter: Name attribute has been dropped upon an existing attribute, the Material Parameters: Parameter: Name attribute is the first being assigned to the query 26 under development, or the Material Parameters: Parameter: Name attribute is not the first attribute being assigned to the query 26 under development. Since this is the first attribute dropped in to the query area 20, the system creates a new query entry, or query element, 26a.

At this point the name to be searched within the database is specified. For example, “melt %” will match any entry that starts with the string “melt”, for example, “melting point”, “melting temperature” or “melting rate”. The “%” is used as a wildcard for any other number of arbitrary characters or numbers. Other wildcard indicators, for example, “*” or “?” may also be used.

Now a new graphical representation 24 of an attribute or structural-element is selected, in particular, and in accordance with the disclosed example, graphical representation 24 of the Material Parameters: Values: Numerical value is selected. The graphical representations 24 of the Material Parameters: Values: Numerical value attribute is then dragged from the tree domain 18 and dropped in the query area 20.

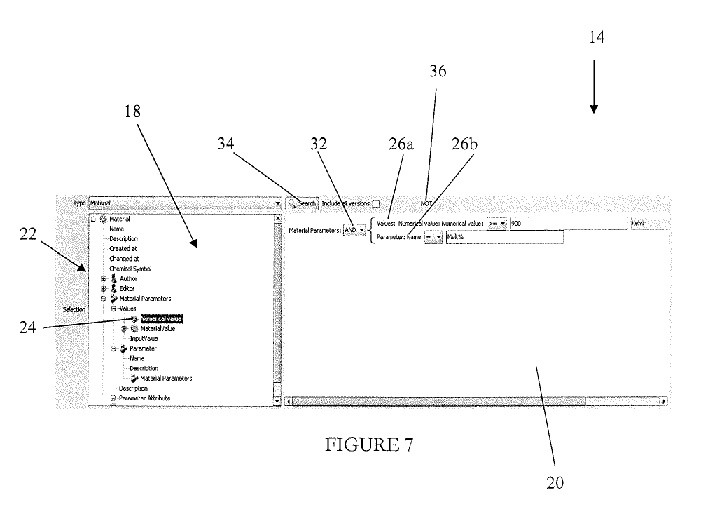

The system 10 then determines whether the graphical representation 24 of the Material Parameters: Values: Numerical value attribute has been dropped upon an existing attribute, the Material Parameters: Values: Numerical value attribute is the first being assigned to the query under development, or the Material Parameters: Values: Numerical value attribute is not the first attribute being assigned to the query under development. Since, and with reference to FIG. 7, this graphical representation 24 of the Material parameters: Values: Numerical value attribute has been dropped upon the prior Material Parameter: Name attribute query element 26a, the system 10 creates a subquery, or second query element, 26b and connects the new material parameters: Values: Numerical value attribute query element 26b with the old Material Parameter: Name attribute query element 26a via an AND operator 32. See FIG. 7.

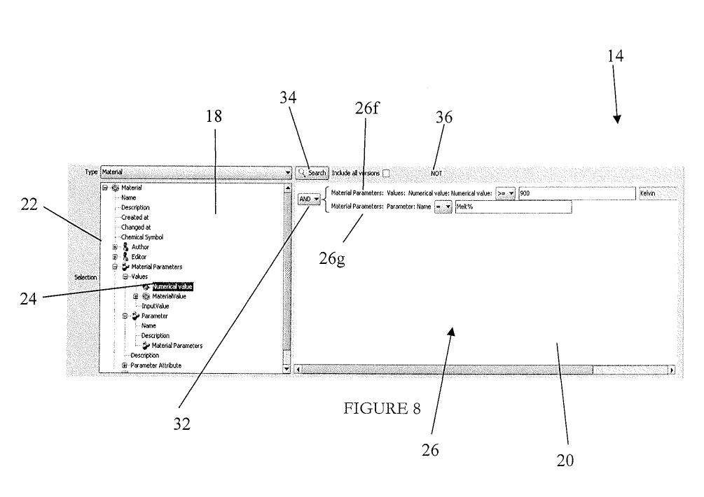

Referring to FIG. 8, if the new graphical representation 24 of the Material Parameters: Values: Numerical value attribute were to be dropped into an open space and not onto the previous Material Parameters: Name attribute, the system 10 creates a new query element 26g and connects the new Material Parameters: Values: Numerical value attribute query element 26g with the previously existing Material Parameters: Parameter: Name Attribute query element 26f via an AND operator 32.

With the Material Parameters: Values: Numerical values attribute query element 26g dropped in position and the Boolean operator selected, a value of greater than or equal to 900K kelvin (symbol: K) is a unit increment of temperature and is one of the seven SI base units) is added.

As discussed above, the system 10 is sensitive to the point where the graphical representation 24 of the attribute or structural-element is dropped. This allows creating queries 26 with different meanings. If the graphical representation 24 of the numeric value algebra attribute query element 26b is dropped on the word parameter query element 26a in the query area 20, the query 26 is created as shown with regard to FIG. 7. If the graphical representation 24 is dropped in an empty area, the resulting query 26 looks like that shown in FIG. 8.

More particularly, in FIG. 7, all materials with a melting point (material parameter) of above 900 K are searched. In the example in FIG. 8, a material having the material parameter melting point and having any parameter with the value of above 900 K may be chosen. The parameter having a temperature of above 900 K can be any parameter, not necessarily the melting point. The operator 32 can be changed by selecting the arrow beside it. The NOT operator 36 can be dragged from the top (above the query area 20). Using this mechanism, the user can very quickly generate a complex query 26 via a drag and drop system.

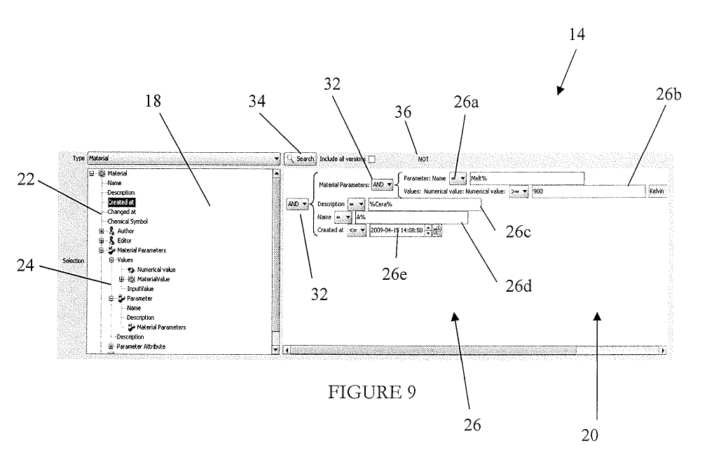

With reference to FIG. 9, additional graphical representations 24 of attributes and/or structural-elements have been added and query elements 26c-e have been created in accordance with the present invention as described above, and the search is for a material with a melting point above 900 K. The description of the material must contain the string “CERA”, the name must begin with “A” and it must be created before the specified date of 15 of Apr. 2009.

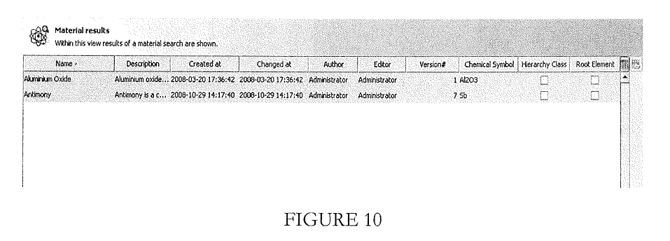

Once the query 26 is completed and confirmed by the user, by pressing search 34, the query 26 is created as an independent XML query and sent to the query engine 30 where it is interpreted, converted to SQL query and executed. The results are returned and shown in a table with the most important properties. See FIG. 10.

While the invention has been disclosed above for use in conjunction with materials, the present invention may be used in conjunction with a variety of processes. For example, it may be used in conjunction with wafer designs, process steps, process graphs, artifacts, assessments, experiments, lots, projects, tools, tracked maskset, tracked process flow, wafer piece, tracking wafers, and/or tracked entities; not only searching the database for these information but can combine queries relating to these different concepts. An example for a relation search is as follows: Search for all “Wafers” that were “processed” at a temperature of more than “500° C.” and are related to the “Project” MyProject. This combines a search for wafers with the search for process steps (processed more than 500° C.) and projects (Name=MyProject) and to find the relations between these (only wafers that are related to both of these).

While the preferred embodiments have been shown and described, it will be understood that there is no intent to limit the invention by such disclosure, but rather, is intended to cover all modifications and alternate constructions falling within the spirit and scope of the invention.

1. A system for creating queries for complex data structures, comprising:
a database populated with data relating to a manufacturing process:
a graphical user interface accessed via a computer linked to the database, the graphical user interface including a tree domain and a query area, the tree domain including a tree representation of structure of the data populating the database, wherein the tree representation includes graphical representations of attributes and/or structural-elements relating to the manufacturing process and populating the database; and
means for dragging and dropping the graphical representations from the tree domain to the query area where the graphical representations are converted to a query based upon operators linking the graphical representations dragged and dropped from the tree domain.

2. The system according to claim 1, wherein the database is a relational database.

3. The system according to claim 1, wherein the query is an XML query.

4. The system according to claim 1, wherein the operators are Boolean operators.

5. The system according to claim 1, wherein the operators are AND, OR and NOT.

6. The system according to claim 1, wherein the data is selected from the group consisting of wafers, materials, parameters, units, single process steps, process step parameters, process step rules, process flows, lots, experiments, users, groups, material types, wafer types, process step types, projects, assessments, wafer pieces, artifacts with linked documents, masksets, tools, models, and machines.

7. The system according to claim 1, wherein a server links the graphical user interface of the computer to the database.

8. The system according to claim 1, wherein the server converts the query generated by the graphical user interface of the computer into an SQL query.

9. The system according to claim 1, wherein the query generated by the graphical user interface of the computer is an XML query.

10. A method for creating queries for complex data structures, comprising:
providing a graphical user interface accessed via a computer, the graphical user interface including a tree domain and a query area;
linking the graphical user interface with a database populated with data relating to a manufacturing process, the graphical user interface including a tree domain having a tree representation of structure of the data populating the database, wherein the tree representation includes graphical representations of attributes and/or structural-elements relating to the manufacturing process and populating the database;
dragging and dropping selective graphical representations from the tree domain to the query area where selected graphical representations are converted to a query based upon operators linking the selected graphical representations dragged and dropped from the tree domain.

11. The method according to claim 10, wherein the database is a relational database.

12. The method according to claim 10, wherein the query is in XML query.

13. The method according to claim 10, wherein the operators are Boolean operators.

14. The method according to claim 10, wherein the operators are AND, OR and NOT.

15. The method according to claim 10, wherein the data is selected form the group consisting of wafers, materials, parameters, units, single process steps, process step parameters, process step rules, process flows, lots, experiments, users, groups, material types, wafer types, process step types, projects, assessments, wafer pieces, artifacts with linked documents, masksets, tools, models, machines.

16. The method according to claim 10, wherein the step of linking includes providing a server that links the graphical user interface of the computer to the database.

17. The method according to claim 16, wherein the server converts the query generated by the graphical user interface of the computer into an SQL query.

18. The method according to claim 17, wherein the query generated by the graphical user interface of the computer is an XML query.
